(19) United States
(12) Patent Application Publication
(10) Pub. No.: US 2011/0276359 A1
(43) Pub. Date: Nov. 10, 2011

(54) INFORMATION PROCESSING APPARATUS, COST FORECAST CALCULATION METHOD, AND COST FORECAST CALCULATION PROGRAM

(76) Inventors: Kentaro Taguchi, Hiratsuka (JP); Ken Igarashi, Miura (JP); Sanae Ikeda, Tokyo (JP)

(21) Appl. No.: 13/034,945

(22) Filed: Feb. 25, 2011

(30) Foreign Application Priority Data
May 7, 2010 (JP) 2010-107314

(51) Int. Cl. G06Q 10/00

(52) U.S. Cl. 705/7.22

(57) ABSTRACT

An information processing apparatus, a cost forecast calculation method, and a cost forecast calculation program are provided that enable the calculation of cost forecast without cost performance data such as initial inventory and warehousing schedule. The information processing apparatus includes: a reception unit for obtaining production plan data indicating the production plan of a product including date data; a plan change unit that changes the initial inventory data to the production plan data based on the product identification data and the plan identification data; and a cost calculation unit that calculate the cost.

### CLAIM OF PRIORITY

The present application claims priority from Japanese application serial no. JP2010-107314, filed on May 7, 2010, the content of which is hereby incorporated by reference into this application.

### FIELD OF THE INVENTION

The present invention relates to an information processing apparatus, a cost forecast calculation method, and a cost forecast calculation program for calculating and presenting a manufacturing cost forecast by production lot.

### BACKGROUND OF THE INVENTION

In recent years, the manufacturing industry has been exposed to severe market changes and parts/materials purchase prices and product selling prices are fluctuating greatly. In such a situation, if order receipt activity and production plan explosion are carried out using costs established once a year or term, a problem of receiving orders under unfavorable conditions or creating an unprofitable production plan may occur. Therefore, it is necessary to carry out order receipt activity and production planning, taking into account the latest cost forecast based on latest production plan and parts/material purchase prices.

As a technique for calculating a cost forecast, there is one disclosed in JPA No. 2004-252710. According to this technique, by calculating a product standard cost using the ABC technique and allocating the production value to an activity unit, it is possible to know production prices and costs by activity and thereby evaluate a production activity with the profit value.

### SUMMARY OF THE INVENTION

Although technique disclosed in JPA No. 2004-252710 enables calculation of a cost forecast based on the latest data, it is necessary to input cost performance data such as initial inventory and warehousing schedule. There is no problem when a performance-based system such as ERP (Enterprise Resource Planning) system and cost control system is provided and thereby the above data can be obtained, but if there is no such system and the above data cannot be obtained, a cost forecast cannot be calculated.

The present invention has been made to solve these problems and an object thereof is to provide an information processing apparatus, a cost forecast calculation method, and a cost forecast calculation program which allow the calculation of cost forecast.

In order to solve the abovementioned problems and achieve the object, the information processing apparatus of the present invention is an information processing apparatus for calculating manufacturing cost of the product, including: a reception unit that obtains production plan data indicating the production plan of a product including date data indicating a reference date representing a time for calculating manufacturing cost of the product, product identification data for identifying a product, plan identification data for identifying production plan of the product at the reference date, the production plan including a required date indicating a time when the product is required and a required quantity of the product at the required date, initial inventory data including the product identification data and stock quantity of the product at the reference date, and expenditure data indicating the expenditure required to produce the product; a plan change unit that changes the initial inventory data to the production plan data based on the product identification data and the plan identification data, sets changed initial inventory identification data to identify changed initial inventory data, which is the initial inventory data after change, as the plan identification data, sets the reference date to the required date, and sets the stock quantity to the required quantity; a production plan explosion unit that repeatedly allocates the stock quantity of the product to be identified by the changed initial inventory identification data until the required quantity of the product to be identified by the changed plan identification data is filled based on the product identification data, the plan identification data, and the changed initial inventory identification data; and a cost calculation unit that calculates the cost, which is an expenditure for producing the product to be identified by the production plan identification data and the product identification data, based on the required quantity of the product allocated by the production plan explosion unit and the expenditure data.

Also, the present invention is a cost forecast calculation method and a cost forecast calculation program to be executed by the above information processing apparatus.

According to the present invention, it is possible to design order receipt activity and production plan with the latest cost forecast based on latest production plan and material purchase price taken into consideration.

### BRIEF DESCRIPTION OF THE DRAWINGS

FIG. 1 shows a configuration of a cost forecast calculation system;

FIG. 2 shows a processing flow of the cost forecast calculation system;

FIG. 3 shows data included in external data;

FIG. 4 shows a configuration of system data;

FIG. 5 shows a configuration of production plan data;

FIG. 6 shows a configuration of BOM (bill of materials) data;

FIG. 7 shows a configuration of shop data;

FIG. 8 shows a configuration of initial inventory data;

FIG. 9 shows a configuration of material cost data;

FIG. 10 shows a configuration of processing cost data;

FIG. 11 shows a calculation method input screen of a calculation method data input unit;

FIG. 12 shows a configuration of changed production plan data;

FIG. 13 shows a processing flow of a plan change process;

FIG. 14 shows a configuration of production plan explosion data;

FIG. 15 shows a processing flow of a production plan explosion process;

FIG. 16 shows a configuration of cost-by-lot data;

FIG. 17 shows a processing flow of a cost calculation process;

FIG. 18 shows an output screen of the cost-by-lot data; and

FIG. 19 shows a hardware configuration of this system.

### DETAILED DESCRIPTION OF THE PREFERRED EMBODIMENTS

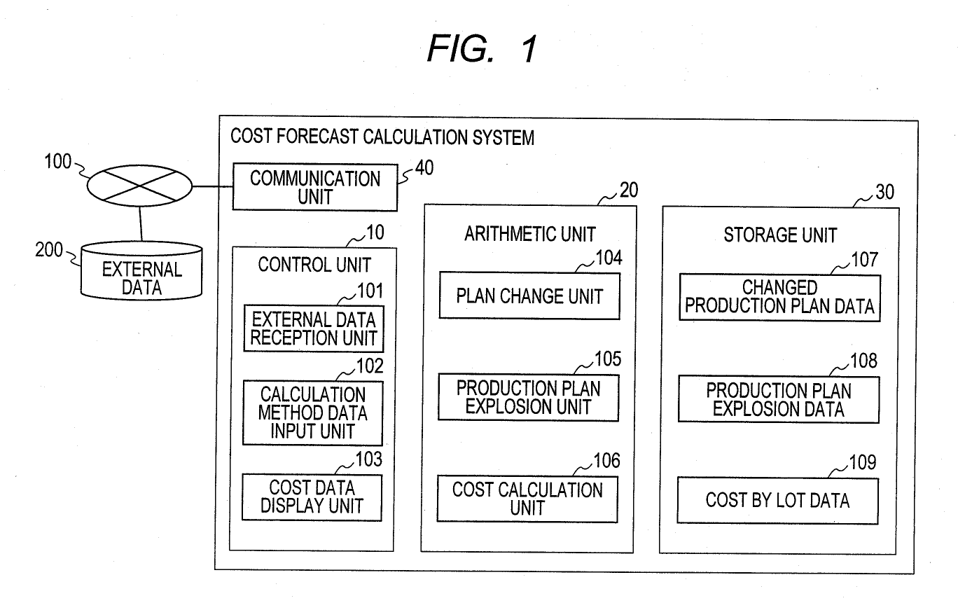

FIG. 1 is a diagram showing a configuration of a cost forecast calculation system according to one embodiment of the present invention. As shown in FIG. 1, the cost forecast calculation system of the present invention includes a control unit 10, an arithmetic unit 20, a storage unit 30, and a communication unit, and data to be processed by the arithmetic unit 20 can be obtained from an external database via a network 100 using the communication unit 40 as an interface.

The network 100 is normally a communication network being managed by user organization, such as LAN (Local Area Network). However, the network 100 is not restricted to LAN, and may be a communication network which partially uses a general public line such as the Internet, WAN (Wide Area Network), and VPN (Virtual Private Network).

The control unit 10 accepts an input for operation from a user at a calculation method data input unit 102, receives external data at an external data reception unit 101 via the network 100, requests arithmetic processing described later from the arithmetic unit 20, receives information about the processing result, and presents it to the user via a cost data display unit 103.

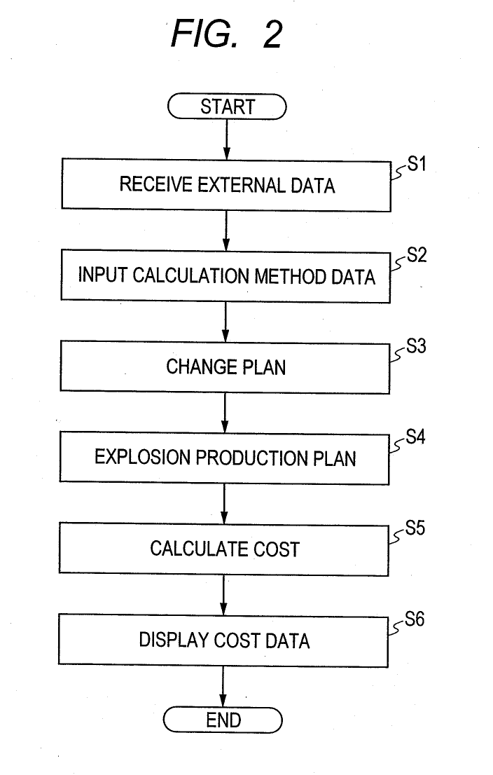

FIG. 2 is a diagram showing a processing flow in the control unit 10 and the arithmetic unit 20. First, the external data reception unit 101 accepts system data 210, production data 220, BOM data 230, shop data 240, initial inventory data 250, material cost data 260, and processing cost data 270 from the external data 200, and performs an external data accepting process S1 to store them in the storage unit 30.

Next, a calculation method input unit 102 performs calculation method data input processing S2 to accept a calculation method input from a user and stores it in the storage unit 30. Then, a plan changing unit 104 performs plan change processing S3 to generate changed production plan data 107 from system data 210, production plan data 220, and initial inventory data 250 stored in the storage unit 30.

Next, a production plan explosion unit 105 performs production plan explosion processing S4 to generate production plan explosion data 108 from changed production plan data 107, part list data 230, and shop data 240 stored in the storage unit 30 and stores it in the storage unit 30. Then, a cost calculation unit 106 performs cost calculation processing S5 to generate cost-by-lot data 109 from production plan explosion data 108, material data 260, and processing cost data 270 stored in the storage unit 30. Finally, a cost data display unit 103 performs cost data display processing S6 to display cost-by-lot data 109 stored in the storage 30.

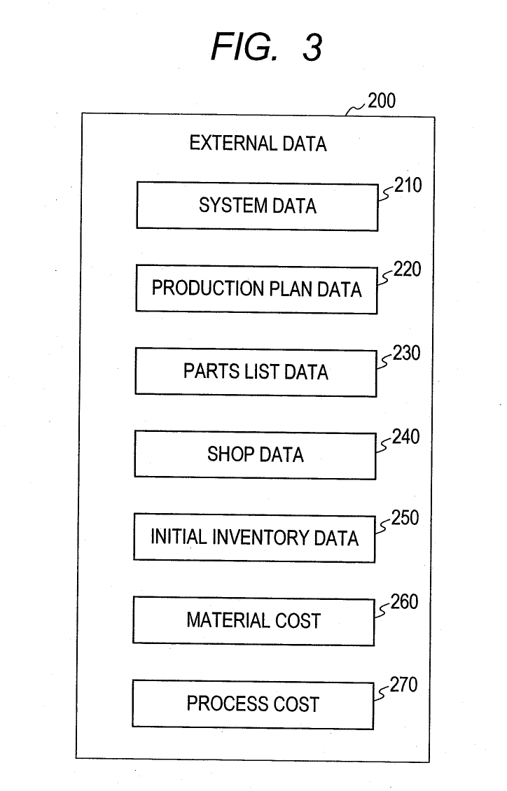

FIG. 3 is a diagram showing an example of a group of data included in the external data 200 that is received by the external data reception unit 101. In the description of this example, the external data 200 includes at least: system data 210 for storing current date; production plan data 220 for storing production plans by product and by time packet; BOM data 230 for a product; shop data 240 for storing information about a shop where products, half-finished products, and parts are manufactured or procured as well as the required lead times for them; initial inventory data 250 for storing the number of products, half-finished products, and parts in stock as of current date; material cost data 260 for storing the purchase price of a part; and processing cost data 270 for storing the processing cost incurred at each shop.

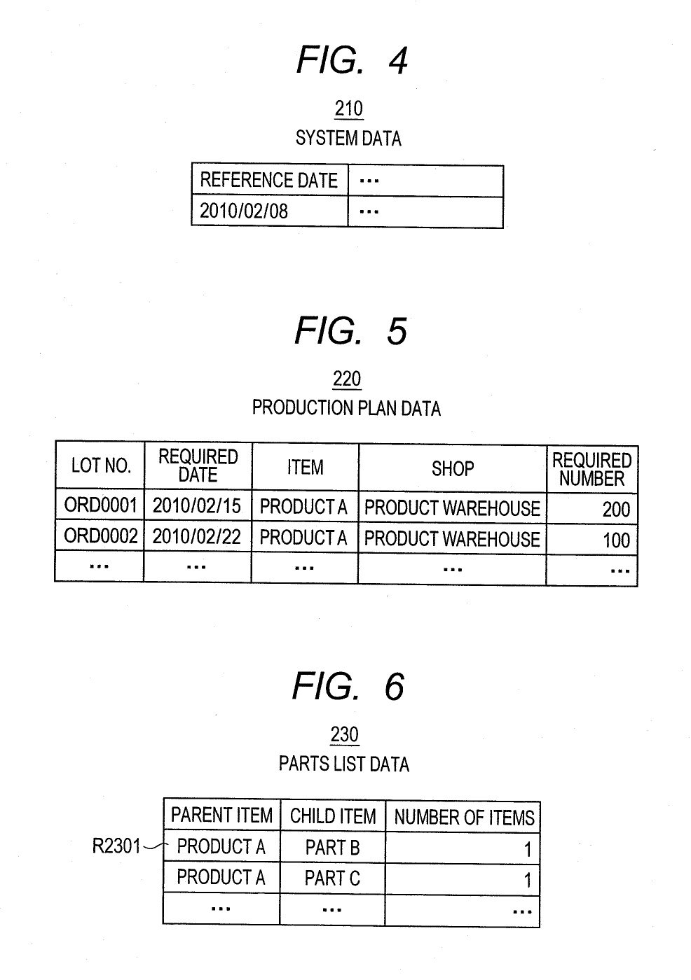

FIG. 4 is a diagram showing a configuration of the system data 210. The system data 210 stores at least reference date. The reference date is a field where date information is stored that identifies current date to be used when performing a cost forecast calculation. The record in the first row shows that current date is Feb. 8, 2010.

FIG. 5 is a diagram showing a configuration of the production plan data 220. In the production plan data 220, lot No., required date, item, shop, and required quantity are stored. The lot No. is a field where the date when a product covered by each production plan is required is stored. The required date is a field where a date when a product covered by each production plan is required. The item is a field where a product name covered by the production plan is stored. The shop is a field where a shop (warehouse or production process) in which a product covered by the production plan needs to be warehoused is stored. The required quantity is a field where required quantity of products covered by the production plan is stored. The records in the first row show that 200 units of product A with lot No. ORD0001 are to be stocked in a product warehouse by 2010 Feb. 15.

FIG. 6 is a diagram showing a configuration of the BOM data 230. In the BOM data 230, parent item, child item, and number of items are stored. The parent item is a field where parent item data of parent and child relationship data on the parts constituting a product is stored. The child item is a field where child item data of parent and child relationship data on the parts constituting a product is stored. The number of items is a field where the number of child items required for producing the parent item is stored. Although the number of items in this example is specified in number of product, it may be specified in length, weight, or volume or product. The records in the first to second rows show that each one unit of part B and part C is required for producing product A.

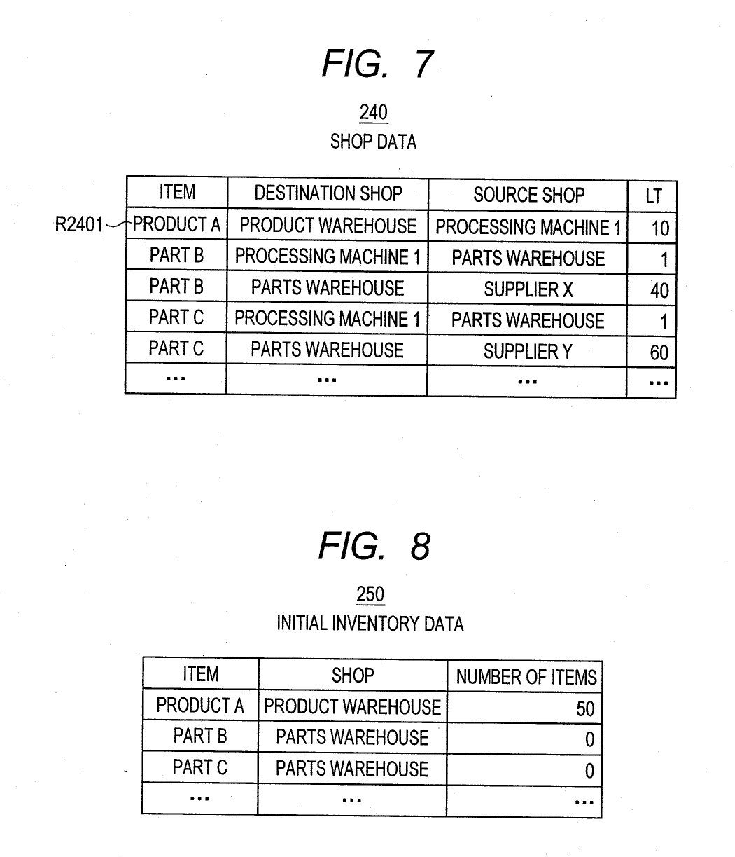

FIG. 7 is a diagram showing a configuration of the shop data 240. In the shop data 240, item, destination shop, source shop, and LT (lead time) are stored. The item is a field where names of the products, half-finished products, and parts are stored. The destination shop is a field where the shops in which the products, half-finished products, and parts originating from source shops are to be used are stored. The source shop is a field where the shops from which the products, half-finished products, or parts are to be supplied after being processed there are stored. The LT is a field where the period required for the products, half-finished products, and parts are to be processed in the source shop and supplied to the destination shop. Although the LT is specified in number of days in this example, it may be specified in number of weeks or number of hours. The records in the first row show that product A is processed by processing machine 1 and cannot be supplied to the product warehouse within 10 days.

FIG. 8 is a diagram showing a configuration of the initial inventory data 250. In the initial inventory data 250, item, shop, and number of items are stored. The item is a field where data to identify names of the products, half-finished products, and parts is stored. The shop is a field where data to identify at which shops the products, half-finished products, and parts exist is stored. The number of items is a field data as to where the number of the products, half-finished products, and parts existing on the reference date is stored. Although the number of items is specified in number in this example, it may be specified in weight or volume. The records in the first row show that 50 units of product A are stocked in the product warehouse.

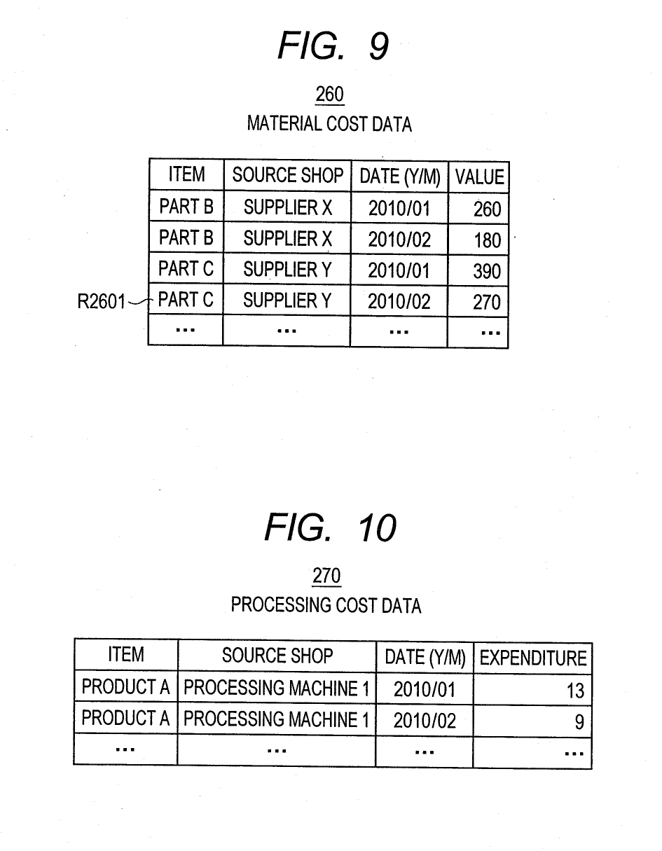

FIG. 9 is a diagram showing a configuration of the material cost data 260. In the material cost data 260, item, source shop, date (Y/M), and value are stored. The item is a field where names of the parts are stored. The source shop is a field where the shop (supplier) from which the part is supplied. The date (Y/M) is a field where value of the part is stored if it differs with year/month. Although the date (Y/M) is specified in month in this example, it may be specified in year or day. The value is a field where purchase price per unit of part in the specified year and month is stored. The records in the first row show that product B was purchased or is to be purchased from supplier X for 260 yen per unit in January 2010.

FIG. 10 is a diagram showing a configuration of the processing cost data 270. In the processing cost data 270, item, source shop, date (Y/M), and cost are stored. The item is a field where names of the products and half-finished products are stored. The source shop is a field where names of the shops in which the products and half-finished products are processed are stored. The date (Y/M) ha is a field where the cost is stored if the cost differs with year/month. Although the date is specified in month in this example, it may be specified in year or day. The cost is a field where processing cost per unit of the product or half-finished product in each year/month is stored. The records in the first row show that product A incurred or is to incur the processing cost of 13 yen per unit in January 2010 on processing machine 1. Although only the processing cost is given in this example, another cost or multiple costs may be given.

These are exemplary data to be stored in the external data 200. Next, a display of the calculation method data input unit 102 in the calculation method data input processing S2 is described.

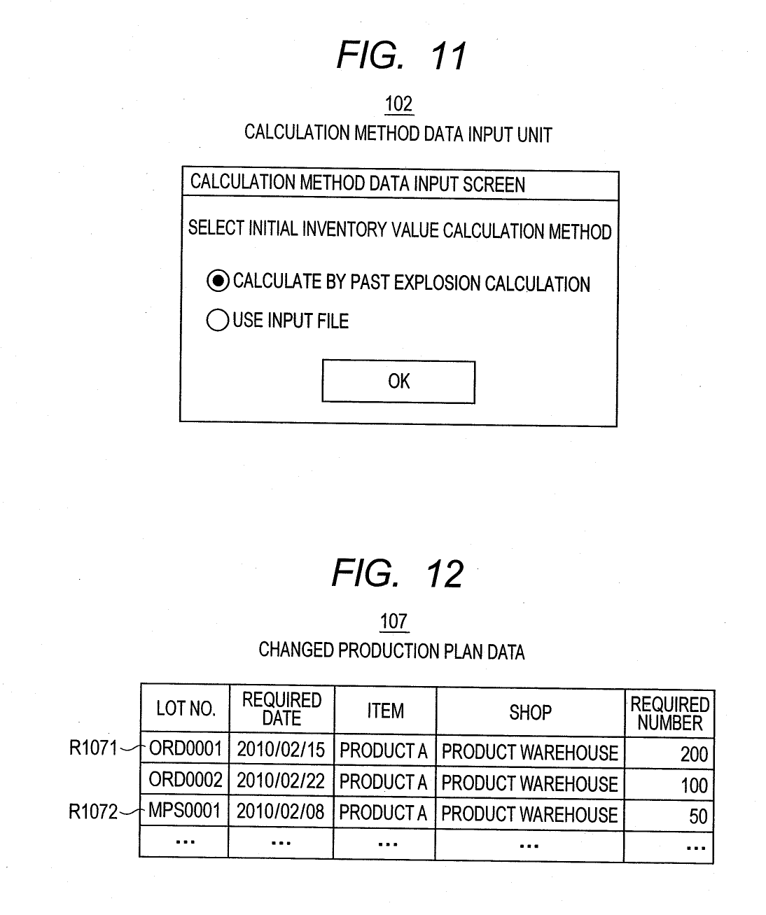

FIG. 11 is a diagram showing an exemplary screen of the calculation method data input unit 102 in the calculation method data input processing S2. On the calculation method input screen, there is a radio button to select whether initial inventory value is to be calculated by means of past explosion calculation or by using an input file. In this example, a user inputs the calculation method via the calculation method input unit 102, but this processing is not indispensable and in that case the past explosion calculation is always performed.

FIG. 12 is a diagram showing a configuration of the changed production plan data 107 to be generated as a result of the plan change processing S3. In the changed production plan data 107, lot No., required date, item, shop, and required quantity are stored.

The lot No. is a field where unique numbers given to identify individual production plans are stored. The required date is a field where dates when products covered by individual production plans are needed are stored. The item is a field where names of products covered by the production plan are stored. The shop is a field where the shop (warehouse or production process) in which products covered by the production plan need to be warehoused is stored. The required quantity is a field where the required quantity of products covered by the production plan is stored.

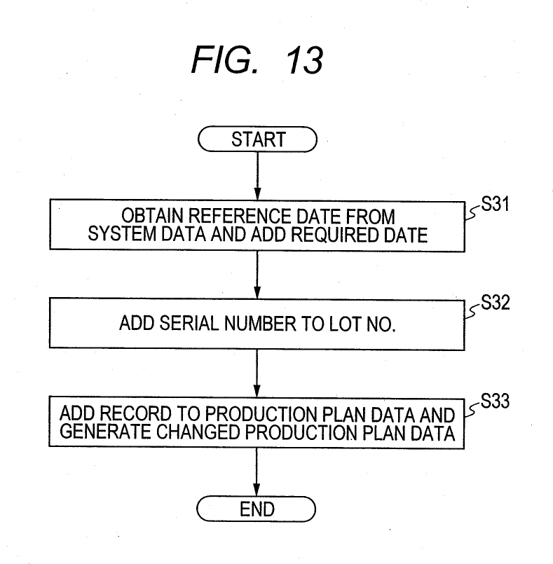

FIG. 13 is a diagram showing a processing flow of the plan change processing S3.

First, the plan change unit 104 adds reference dates obtained from the system data 210 as required dates to all the records of the initial inventory data 250 (step S31). Next, the plan change unit 104 adds a serial number starting with “MPS” to each record to indicate that it was changed from the initial inventory (step S32). Finally, the plan change unit 104 adds the above-mentioned record to the production plan data and stores it in the storage unit 30 as the changed production plan data 107 (step S33).

According to record R1072 in the third row of the changed production plan data 107 shown in FIG. 12, the reference date “2010 Feb. 8” obtained from the system data 210 as required date and the serial number “MPS0001” as lot No. are added to the record in the first row of the initial inventory data 250 by the plan change processing S3.

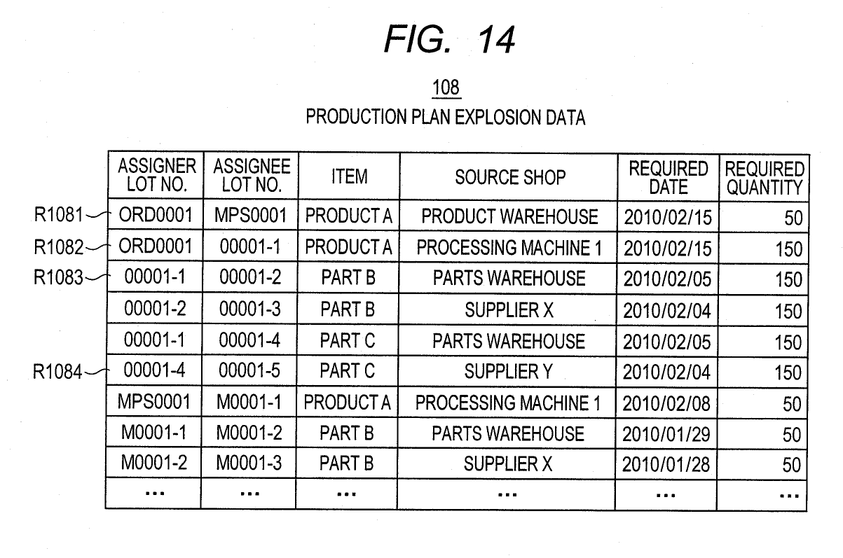

FIG. 14 is a diagram showing a configuration of the production plan explosion data 108 to be generated as a result of the production plan explosion processing S4. the production plan explosion data 108, allocated lot No., target lot No., item, source shop, required date, and required quantity are stored.

The allocating lot No. is a field where data to identify the lot No. to which the lot No. of the product, half-finished product, or part is allocated is stored. The target lot No. is a field as to data where a lot No. to which the product, half-finished product, or part is allocated is stored. The item is a field where data to identify names of the products, half-finished products, and parts to be allocated is stored. The source shop is a field data to identify at which shops the products, half-finished products, and parts to be allocated are processed is stored. The required date is a field where the date when the products covered by individual product plans are required is stored. The required quantity is a field where the required quantity of products covered by the production plan is stored.

According to the records in the first to second rows, 50 units of product A of lot No. “MPS0001” stocked in the product warehouse on 2010 Feb. 15 and 150 units of product A of lot No. “00001-1” are allocated to lot No. “ORD0001” of product A.

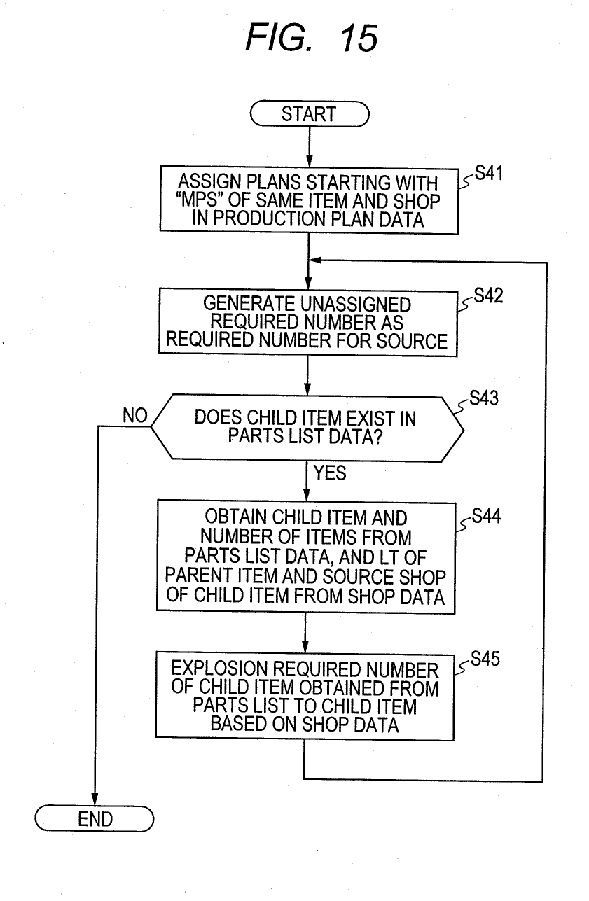

FIG. 15 is diagram showing a processing flow of the production plan explosion processing S4.

First, the production plan explosion unit 105 allocates, out of the records of the changed production plan explosion data 107 (R1071, for instance) whose item and shop are the same and lot No. starts with “MPS”, the record R1072 whose required date is before that of the record R1071, creates a new record R1081 in the production explosion data 108, and stores the lot No. of the record R1071 in the allocating lot No., the lot No. of the record R1072 in the target lot No., the item of the record R1071 in the item, the shop of the record R1072 in the source shop, and the required quantity of the record R1072 in the require number respectively (step S41).

Next, the production plan explosion unit 105 creates, for the required quantity not allocated at step S41, a new record R1082 in the production plan explosion data 108, and stores the lot No. of the record R1071 in the allocating lot No., a newly created serial number in the target lot No., the item of the record R1071 in the item, the required date of the R1071 in the required date, and the unallocated required quantity in the required quantity respectively. For the source shop, the production plan explosion unit 105 searches a record with the same item and destination shop as those of the record R1071, and obtains the source shop of that record R2401 and stores it (step S42).

Next, the production plan explosion unit 105 searches a record whose parent item of the BOM data 230 is the same as item of the record R1082 created in the production plan explosion data 108 at step S42, and if such record exists goes to the next step S44 and if not ends the processing (step S43).

Next, the production plan explosion unit 105 searches a record (R2301 for instance) whose parent item of the BOM data 230 is the same as the item of the record R1082 created in the production plan explosion data 108 at step S42, obtains the child item and number of items, and searches a record (R2401, for instance) whose item of the record R1082, the item of the source shop and shop data 240, and the source shop are the same (step S44).

Finally, the production plan explosion unit 105 creates a new record R1083 in the production plan explosion data 108, stores the lot No. of the record R1082 in the allocating lot No., a newly created serial number in the target lot No., the child item obtained at step S44 in the item, a value calculated by subtracting the LT obtained at step S44 from the required date of the record R1082 in the required date, and a value calculated by multiplying the required quantity of the R1082 by the number of items obtained at step S44 in the required quantity respectively, and returns to step S42 (step S45). The production plan explosion unit 105 performs this processing for all the records of the production plan data.

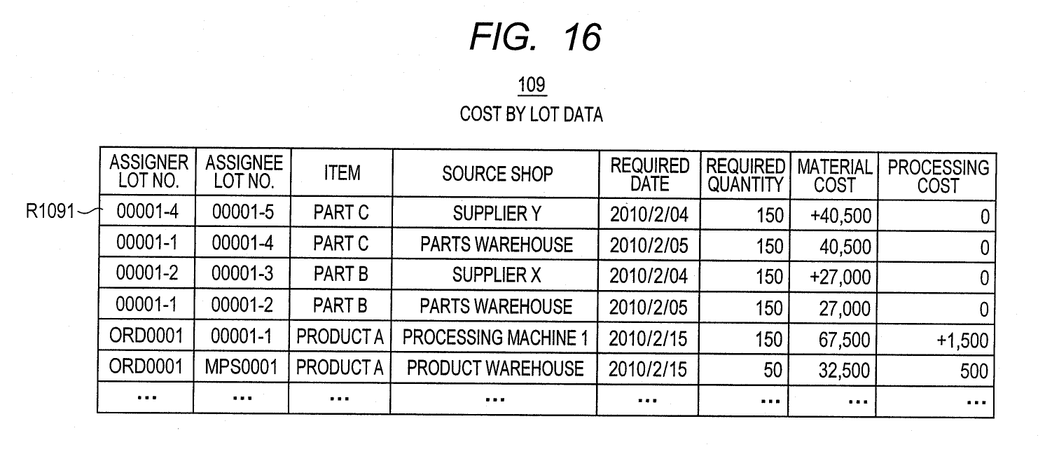

FIG. 16 is a diagram showing a configuration of the cost-by-lot data 109 to be generated as a result of the cost calculation processing S5. In the cost-by-lot data 109, allocating lot No., target lot No., item, source shop, required date, required quantity, material cost, and processing cost are stored.

The allocating lot No. is a field where data to identify the lot No. from which allocation of the product, half-finished product, or part is requested is stored. The target lot No. is a field where the lot No. to which the product, half-finished product, or part of the allocating lot No. is allocated is stored. The item is a field where data to identify names of the products, half-finished products, and parts to be allocated is stored. The source shop is a field where data to identify at which shops the products, half-finished products, and parts to be allocated are processed and supplied is stored. The required date is a field where the date when the product, half-finished product, or part covered by each product plan is required is stored. The required quantity is a field where required quantity of the product, half-finished product, or part is stored. The material cost is a field where total value of the material cost required to produce required quantity of the product, half-finished product, or part is stored, and the processing cost is a field where total value of the processing cost required to required quantity of the product, half-finished product, or part. Although material cost and processing cost are given as the cost in this example, another cost may be given in addition to them but there must be at least one cost.

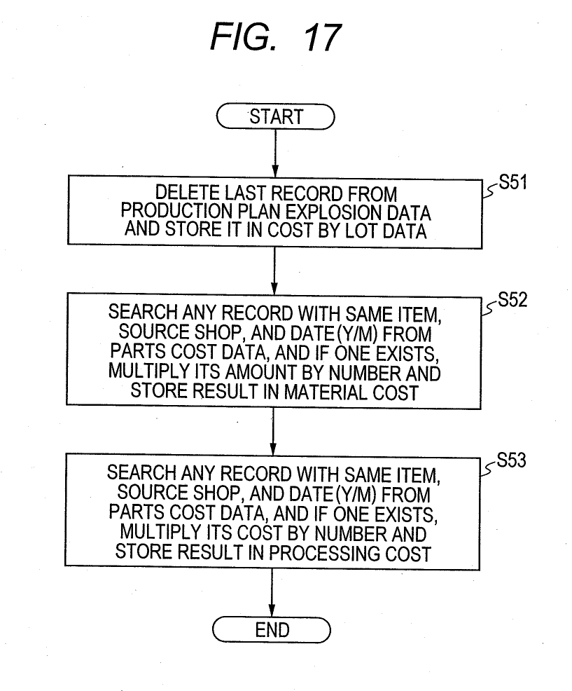

FIG. 17 is diagram showing a processing flow of the cost calculation processing S5.

First, the cost calculation unit 106 extracts, from the production expansion data 108, a record (R1084, for instance) whose allocating lot No. does not exist in the target lot No. of other records, deletes that record and at the same time creates a new record (R1091) in the cost-by-lot data 109, and stores allocating lot No., target lot No., item, source shop, required date, and required quantity (step S51).

Next, the cost calculation unit 106 retrieves from the material cost data 260 a record (R2601) whose item, source shop, and required (Y/M) are the same as those of record R1091 created at step 51, and if exists, obtains that value and add the required quantity and the obtained value to the material cost field of record R1091 (step S52).

Next, the cost calculation unit 106 the cost calculation unit 106 retrieves from the processing cost data 270 a record (R2601) whose item, source shop, and required (Y/M) are the same as those of record R1091 created at step 51, and if exists, obtains that cost and add the required quantity of record R1091 and the obtained value to the processing cost field of record R1091 (step S53). The cost calculation unit 106 performs this processing for all the production plan explosion data 108.

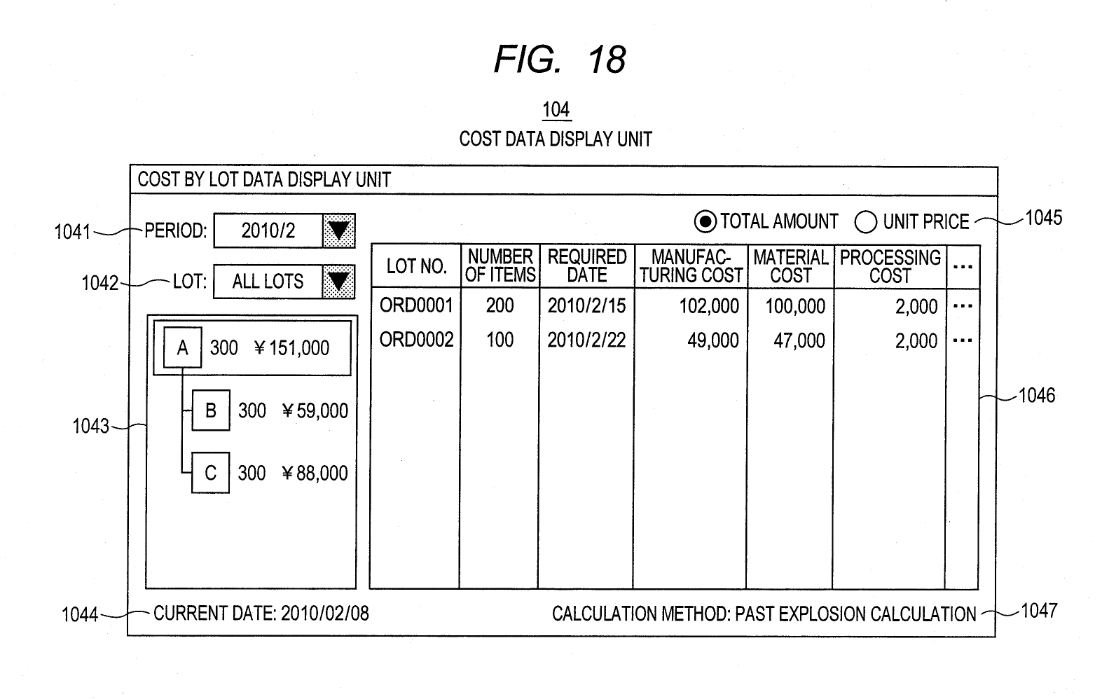

FIG. 18 is a diagram showing a screen of the cost data display unit 104 that collects the cost-by-lot data at the cost data display processing S6 from the cost-by-lot data 109 based on the product configuration, and displays it.

The cost data display unit 104 includes period selection area 1041, lot selection area 1042, product configuration display area 1043, current date display area 1044, value selection area 104t, cost-by-lot display area 1046, and calculation method display area 1047.

The period selection area 1041 is an area where it is possible to select the period of data to be displayed in the product configuration display & selection area 1043 and the cost-by-lot display area 1046. In this example, “2010/2” is selected for the display period and therefore the data to be displayed in the product configuration display & selection area 1043 and the cost-by-lot display area 1046 is limited to that for February 2010. In the period selection area 1041, year and month may be selected from a pull-down menu or may be directly input.

The lot selection area 1042 is an area where it is possible to select a lot No. to be displayed in the product configuration display area 1043 and the cost-by-lot display area 1046. In this example, “all lots” is selected for lot No. to be displayed, data to be displayed in the product configuration display area 1043 and the cost-by-lot data display area 1046 is for all lots. In the period selection area 1041, lot No. may be selected from a pull-down menu or may be directly input.

The product configuration display & selection area 1043 is an area where a tree-shaped parent and child relationship generated from the parent item and child item of the BOM data 230, the total number of items and total manufacturing cost extracted from the same item record in the cost-by-lot display area 1046 are displayed. In this example, the item A and its total number of items and total manufacturing cost are enclosed with a line, indicating that the item A is selected.

The current date area 1044 is an area where the reference date obtained from the system data 210 is displayed. The value selection area 1045 is an area where selection between total value and unit value obtained by dividing the total value by number of items is made for the values to be displayed in the manufacturing cost, material cost, and processing cost fields in the cost-by-lot display area 1046.

The cost-by-lot display area 1046 is an area where, for the items selected in the product configuration display area 1043, records whose items are the same and source shop is warehouse are extracted cost-by-lot data 109, and allocating lot No. is displayed in the lot No. field, item in the item field, required date in the required date field, number of items in the number of items, total of material cost and processing cost in the manufacturing cost field, material cost in the material cost field, and processing cost in the processing cost field respectively.

The calculation method field 1047 is an area where whether the initial inventory value, etc. is to be calculated by past explosion calculation or by using an input file in the calculation data input unit 102 is selected, in the calculation method data input processing 2. In this example, “calculate by past explosion calculation” is selected in the calculation method data input unit 102 and therefore “past explosion calculation” is displayed in the calculation method field 1047.

As the display method for indicating that initial inventory value, etc. was calculated by the past explosion calculation, a method of changing the color of the material cost & processing cost data in the cost-by-lot display area 1046 or a method of marking the record in the cost-by-lot display area 1046 may be used.

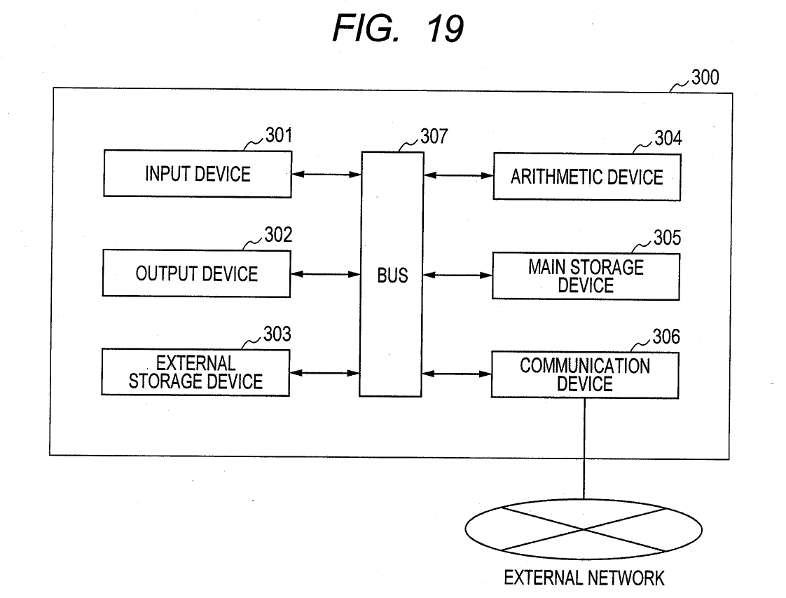

FIG. 19 is a diagram showing a hardware configuration of a cost forecast calculation system 300 of this embodiment.

In this embodiment the cost forecast calculation system 300 is such a computer as PC (personal computer), workstation, or server. The cost forecast calculation system 300 includes an input device 301, an output device 302, an external storage device 303, an arithmetic device 304, a main storage device 305, a communication device 306, and a bus 307 interconnecting these devices.

The input device 301 is for example a keyboard, a mouse, a touch pen, or other pointing device for accepting an input. The output device 302 is for example a display for displaying images and characters. The external storage device 303 is such a nonvolatile storage device as hard disk device or flash memory.

The arithmetic device 304 is such an arithmetic device as CPU (Central Processing Unit). The main storage device 305 is such a memory device as RAM (Random Access Memory). The communication device 306 is a wireless communication device performing wireless communications via an antenna or a wired communication device performing wired communications via cables. The storage unit 30 of the cost forecast calculation system 300 is realized by the main storage device 305 or external storage device 303 of the cost forecast calculation system 300.

Also, the external data reception unit 101, communication method data input unit 102, cost data display unit 103, and arithmetic unit 20 of the cost forecast calculation system 300 are realized by a program that causes the arithmetic device 304 of the cost forecast calculation system 300 to perform processing. This program is stored in the main storage device 305 or the external storage device 303 and loaded on the main storage device 305 to be executed by the arithmetic device 304.

Specifically, this program is composed of modules including the units of the cost forecast calculation system 300 (i.e., external data reception unit, calculation method input unit, cost data display unit, plan change unit, production plan explosion unit, and cost calculation unit), and in terms of hardware, the program is read from the storage device, executed to load each unit mentioned above on the main storage, and generated on the external data reception unit, calculation method data input unit, cost data display unit, plan change unit, production plan explosion unit, and cost calculation unit. The communication unit 100 of the cost forecast calculation system 300 is realized by the communication device 306 of the cost forecast calculation system 300.

Thus, in the cost forecast calculation system, the external data reception unit 101 obtains: system data 210 indicating a reference date representing the date on which the manufacturing cost of a product is calculated; production plan data 220 indicating the production plan for the product that includes an item for identifying the product, a lot No. for identifying the production plan for the product on the reference date, a required date indicating the date on which the product is required, and a required quantity of the product on the required date; initial inventory data 250 including items and the number of items; and cost data (material cost data 260, processing cost data 270) required to product the product, the plan change unit 104: changes the initial inventory data 250 to the production plan data 220 based on the item and lot No.; sets the changed initial inventory identification data for identifying the changed initial inventory data which is initial inventory data 250 after change as the lot No.; sets the reference date to the required date; and sets the stock quantity to the required quantity, the production plan explosion unit 105 allocates the stock quantity of the product identified by the changed initial inventory identification data repeatedly until the required quantity of the product allocated by the production plan explosion unit 105 is filled based on the item, lot No., and changed initial inventory identification data, and the cost calculation unit 106 calculates the manufacturing cost for the product for every lot No. and product based on the required quantity and cost data of the products allocated by the production plan explosion unit 105. It is therefore possible to perform an order receipt activity and production plan creation taking into account the latest cost forecast based on the latest production plan and material purchase price.

That is, in the cost forecast calculation system, by virtually calculating the cost performance data such as initial inventory and warehousing schedule using the past material purchase price data and processing cost data, it is possible to receive orders and create a production plan that take into account the latest cost forecast by lot based on the latest production plan and material purchase price, and thereby profits are increased by receipt of orders under favorable conditions and creation of profitable production plans.

The program to be executed on the cost forecast calculation system 300 of this embodiment may be provided by an installable or executable file stored on computer-readable storage media such as CD-ROM (Compact Disc Read Only Memory), flexible disk, CD-R (Compact Disc Recordable), and DVD (Digital Versatile Disc).

Also, the program executed on the cost forecast calculation system 300 of this embodiment may be provided by storing it on a computer connected to a network such as the Internet and downloading via the network. Further, it is possible to provide or distribute the program to be executed on the cost forecast calculation system 300 via the Internet or the like, or preinstall on a ROM or the like.

The present invention is not restricted to the above embodiment, but can be implemented by modifying the components within the scope and spirit of the present invention. Also, various inventions can be formed by appropriately combining multiple components disclosed in the above embodiment. For example, some components may be deleted from the components shown in the embodiment. Further, components of different embodiments may be combined appropriately.

What is claimed is:

1. An information processing apparatus for calculating manufacturing cost of a product, comprising:
a reception unit that obtains production plan data indicating a production plan of a product including date data indicating a reference date representing a time for calculating manufacturing cost of the product, product identification data for identifying the product, plan identification data for identifying production plan of the product at the reference date, the production plan including a required date indicating a time when the product is required and a required quantity of the product at the required date, initial inventory data including the product identification data and stock quantity of the product at the reference date, and expenditure data indicating an expenditure required to produce the product;
a plan change unit that changes the initial inventory data to the production plan data based on the product identification data and the plan identification data, sets changed initial inventory identification data to identify changed initial inventory data, which is the initial inventory data after change, as the plan identification data, sets the reference date to the required date, and sets the stock quantity to the required quantity;
a production plan explosion unit that repeatedly allocates the stock quantity of the product to be identified by the changed initial inventory identification data until the required quantity of the product to be identified by the changed plan identification data is filled based on the product identification data, the plan identification data, and the changed initial inventory identification data; and
a cost calculation unit that calculates the cost, which is expenditure for producing the product to be identified by the production plan identification data and the product identification data, based on the required quantity of the product allocated by the production plan explosion unit and the expenditure data.

2. The information processing apparatus according to claim 1,
Wherein the reception unit further obtains the product identification data, part data including part identification data for identifying parts constituting the product to be identified by the product identification data, and material cost data including the part identification data and part value data indicating a value of the part;
the production plan explosion unit obtains the part value data for each of the parts to be identified by the part identification data when the product is allocated; and
the cost calculation unit calculates the cost for each of the part value data obtained by the production plan explosion unit.

3. The information processing apparatus according to claim 1, further comprising a calculation method input acceptance unit that accepts selection data indicating whether the cost is calculated by calculation or calculated using input date other than the calculation.

4. The information processing apparatus according to claim 3, further comprising a cost data display unit that displays calculation method data indicating whether the cost has been calculated by calculation or calculated using the input data as well as the cost calculated by the cost calculation unit.

5. A cost forecast calculation method to be performed in an information processing apparatus for calculating a manufacturing cost of a product, comprising:
a reception step for obtaining production plan data indicating a production plan of a product including date data indicating a reference date representing a time for calculating manufacturing cost of the product, product identification data for identifying the product, plan identification data for identifying production plan of the product at the reference date, the production plan including a required date indicating a time when the product is required and a required quantity of the product at the required date, initial inventory data including the product identification data and stock quantity of the product at the reference date, and expenditure data indicating an expenditure required to produce the product;
a plan change step for changing the initial inventory data to the production plan data based on the product identification data and the plan identification data, setting changed initial inventory identification data to identify changed initial inventory data, which is the initial inventory data after change, as the plan identification data, setting the reference date to the required date, and setting the stock quantity to the required quantity;
a production plan explosion step for repeatedly allocating the stock quantity of the product to be identified by the changed initial inventory identification data until the required quantity of the product to be identified by the changed plan identification data is filled based on the product identification data, the plan identification data, and the changed initial inventory identification data; and
a cost calculation step for calculating the cost, which is expenditure for producing the product to be identified by the production plan identification data and the product identification data, based on the required quantity of the product allocated by the production plan explosion unit and the expenditure data.

6. The cost forecast calculation method according to claim 5
wherein the reception step further obtains the product identification data, part data including part identification data for identifying parts constituting the product to be identified by the product identification data and material cost data including the part identification data and part value data indicating a value of the part;
the production plan explosion step obtains the part value data for each of the parts to be identified by the part identification data when the product is allocated; and
the cost calculation step calculates the cost for each of the part value data obtained in the production plan explosion step.

7. A cost forecast calculation program to cause a computer to execute:
a reception step for obtaining production plan data indicating a production plan of a product including date data indicating a reference date representing a time for calculating manufacturing cost of the product, product identification data for identifying the product, plan identification data for identifying production plan of the product at the reference date, the production plan including a required date indicating a time when the product is required and a required quantity of the product at the required date, initial inventory data including the product identification data and stock quantity of the product at the reference date, and expenditure data indicating an expenditure required to produce the product;
a plan change step for changing the initial inventory data to the production plan data based on the product identification data and the plan identification data, setting changed initial inventory identification data to identify changed initial inventory data, which is the initial inventory data after change, as the plan identification data, setting the reference date to the required date, and setting the stock quantity to the required quantity;
a production plan explosion step for repeatedly allocating the stock quantity of the product to be identified by the changed initial inventory identification data until the required quantity of the product to be identified by the changed plan identification data is filled based on the product identification data, the plan identification data, and the changed initial inventory identification data; and
a cost calculation step for calculating the cost, which is expenditure for producing the product to be identified by the production plan identification data and the product identification data, based on the required quantity of the product allocated by the production plan explosion unit and the expenditure data.

8. The cost forecast calculation program according to claim 7,
wherein the reception step further obtains the product identification data, part data including part identification data for identifying parts constituting the product to be identified by the product identification data and material cost data including the part identification data and part value data indicating a value of the part; and
the production plan explosion step obtains the part value data for each of the parts to be identified by the part identification data when the product is allocated.
